(19) United States
(12) Patent Application Publication
(10) Pub. No.: US 2015/0283007 A1
(43) Pub. Date: Oct. 8, 2015

(54) Rigid, Inflatable Stretcher and Related Systems and Methods

(71) Applicant: IDS Global, Inc., Gig Harbor, WA (US)

(72) Inventor: Kenneth John Carlson, Medina, OH (US)

(73) Assignee: IDS Global, Inc., Gig Harbor, WA (US)

(21) Appl. No.: 14/645,264

(22) Filed: Mar. 11, 2015

Related U.S. Application Data
(60) Provisional application No. 61/967,144, filed on Mar. 11, 2014.

(51) Int. Cl. A61G 1/013; A61G 1/02; A61G 1/00

(52) U.S. Cl. CPC A61G 1/013; A61G 1/00; A61G 1/02

(57) ABSTRACT

A rigid, inflatable stretcher provides the capability to carry a person who may be injured or otherwise not capable of moving them self from an inaccessible or dangerous area, such as a combat zone, a steep canyon, and/or a mountain side. The stretcher may be designed to be inflatable with durable and rugged materials providing protection and comfort for the person being carried by it. The stretcher may be designed to be easily stowable, transportable and deployable so that it can serve its intended purpose of carrying a person from a remote or hostile area.

### CROSS REFERENCE TO RELATED APPLICATION AND CLAIM OF PRIORITY

This application claims priority from commonly owned U.S. Provisional Patent Application 61/967,144 filed 11 Mar. 2014, and titled “Rigid Inflatable Stretcher”, presently pending and incorporated by reference.

### FIELD OF THE TECHNOLOGY

The present technology relates to methods and apparatuses for transporting injured persons in various environments, including battlefield casualties, accidents requiring emergency medical services and other situations in which transportation from injury site to medical facility is required.

### BACKGROUND

The need for a lightweight, portable, rigid, durable and easily repairable stretcher system has long been recognized by the Armed Forces and emergency medical services for evacuating and transporting injured service members and other persons from a variety of environments that include active and more benign conditions such as combat zones or remote training sites (for example, in rugged terrain not readily accessible by wheeled vehicles). Current systems in use, though meeting the need for portability and weight restrictions, do not fulfill the need for rigidity, durability, and portability. In addition, current systems in use sacrifice patient stability and comfort in an attempt to achieve being portable and lightweight. Ultimately, however, these systems have proved to be less than satisfactory as they are complicated to use and can potentially impact the mission when issues arise due to the inability to transport victims effectively and rapidly, especially during jump missions that are commonly performed by certain elite units of the United States Air Force (as, for example, the USAF Para-rescue Operators) or highly precarious environments that involve extremely vertical terrain, fire, and other issues regarding unpredictability. Moreover, lack of patient stability can lead to further injury, especially in those patients presenting with spinal injuries, a situation often encountered on the steep and rugged terrain typically found, for example, in the Afghanistan theater of operations. Similar situations are faced by first responders of civilian emergency medical services (EMS) organizations, who often must reach an injured person trapped, for example, on a remote canyon hillside, stabilize the patient and prepare him or her for transport. It is common for these types of medical evacuations to be conducted by helicopter, requiring the medical stretcher to be very rigid, stable and capable of superior performance in hoisting conditions.

There have been many attempts over the years to meet this need for a lightweight, portable, rigid and durable stretcher system. Certain versions developed and brought to market offer various features that meet some of the stated needs listed herein. One concept is a lightweight stretcher comprised of hard plastic sections connected together, allowing the stretcher to be folded up. While offering the advantages of being lightweight and portable, this concept has proved to lack durability in the field, and offers limited rigidity and patient comfort.

Another similar concept is a single sheet of hard plastic material with joints, allowing the stretcher to be folded up in sections. The disadvantages of this version are the same as those listed above.

Another concept is an inflatable stretcher that can be rolled up when deflated. This concept offers the advantages of being lightweight and portable, but offers limited rigidity and durability. Furthermore, should the chamber be compromised the stretcher system will fail and be incapable of performing its mission.

Thus, there is a need for a stretcher system designed to be lightweight, portable, rigid, durable and easily repairable that is capable of withstanding the conditions of extreme environments, such as those found in combat zones or other rugged and remote areas not easily reached by wheeled vehicles or other conventional means.

### SUMMARY

In an aspect of the invention, a rigid, inflatable stretcher includes a main section, a restraint system, a hoisting system, and a system for and transport. The main section of the stretcher includes one or more inflatable panels that includes a drop-stitch to connect a top region of the panel to a bottom region of the panel. When air or some other fluid is injected into the panel the pressure generated between the top and bottom regions causes the top region to move away from the bottom region. To keep the panel in the configuration of a thin yet wide shape, such as a plate, the drop-stitch holds the top region dose to the bottom region.

### BRIEF DESCRIPTION OF THE FIGURES

FIG. 1 shows a perspective view of a stretcher, according to an embodiment of the invention.

Each of FIGS. 2a and 2b shows another view of the stretcher shown in FIG. 1; FIG. 2a shows the stretcher inflated, and FIG. 2b shows the stretcher deflated; each according to an embodiment of the invention.

FIG. 3 shows a view of a stretcher, according to another embodiment of the invention.

FIG. 4 shows a view of a stretcher, according to yet another embodiment of the invention.

FIG. 5 shows a view of a panel, according to an embodiment of the invention.

FIG. 6 shows a view of a panel according to another embodiment of the invention.

FIG. 7 shows a view of a stretcher, according to another embodiment of the invention.

FIG. 8a shows a view of a hoisting system included in a stretcher, according to an embodiment the invention.

FIG. 8b shows a partial view of the hoisting system shown in FIG. 8a, according to an embodiment of the invention.

FIG. 9 shows a view of the stretcher, according to yet another embodiment of the invention.

### DETAILED DESCRIPTION

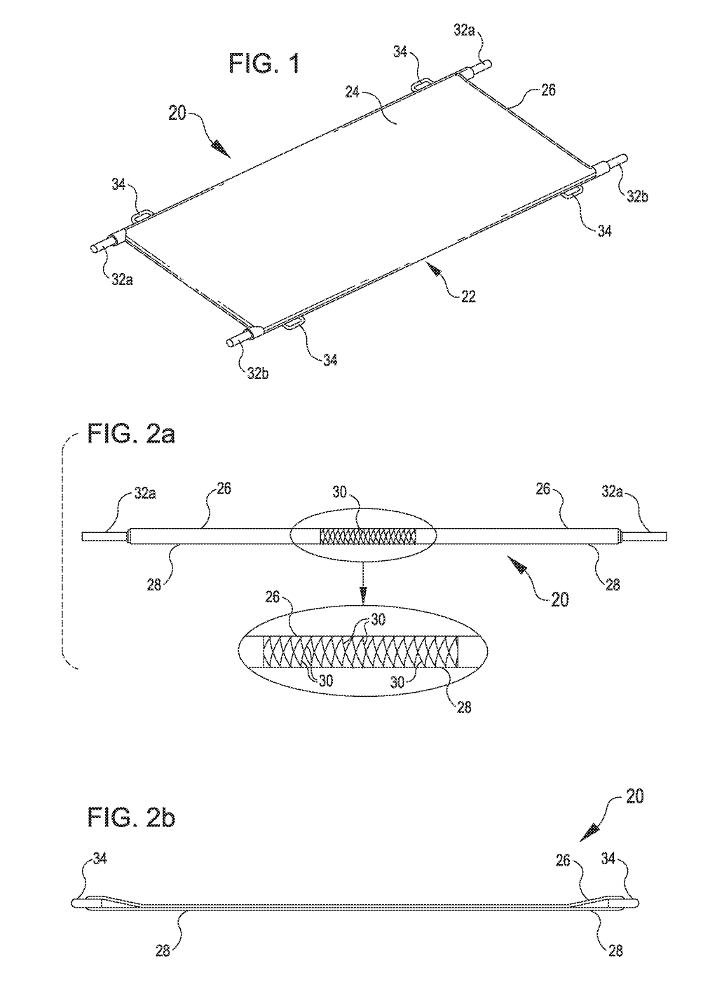

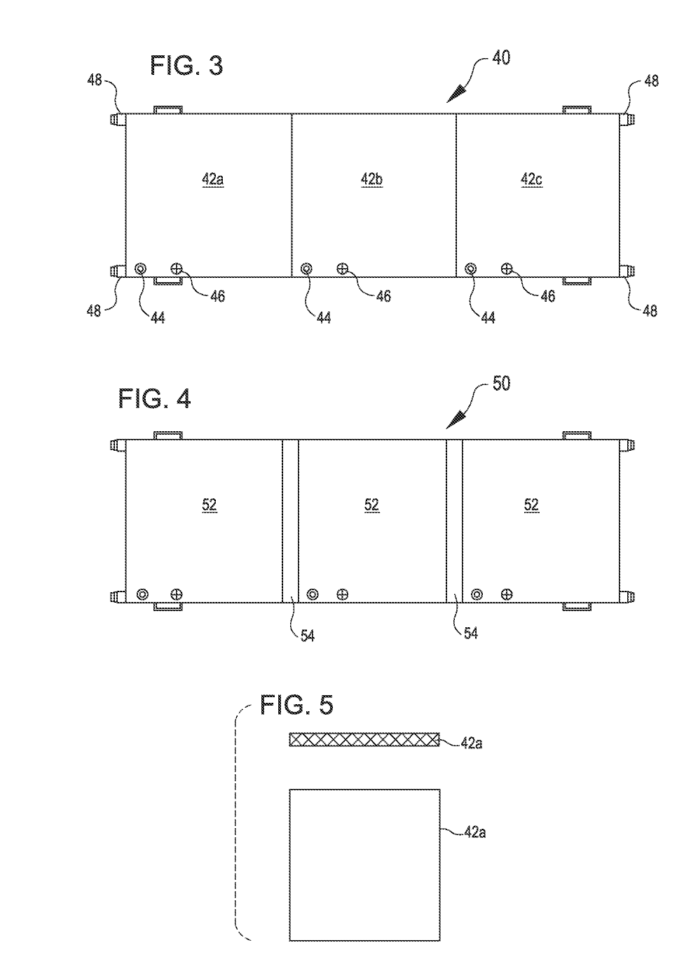

FIG. 1 shows a perspective view of a stretcher 20, according to an embodiment of the invention. The stretcher 20 includes a main section 22 that includes a panel 24 that may be inflated with air or any other desired fluid to generate pressure inside the panel. The panel 24 includes a top region 26 (see FIGS. 2a and 2b) a bottom region 28 (see FIGS. 2a and 2b), and a drop-stitch 30 that couples the top region 26 to the bottom region 28. When air or some other fluid is injected into the panel the pressure generated between the top and bottom regions 26 and 28, respectively, causes the top region 26 to move away from the bottom region 28 (see FIG. 2a). To keep the panel in the configuration of a thin yet wide shape, such as a plate, the drop-stitch 30 (discussed in greater detail in conjunction with FIGS. 3 and 5) holds the top region 26 close to the bottom region 28. When inflated, the panel 24 is rigid and can support the weight of person lying on top it, and when deflated the panel 24 and thus stretcher 20 is easily folded up to a size that facilitates easy transportation.

The stretcher 20 also includes two poles 32a and 32b that one can grip to carry a person lying, sitting or otherwise on the panel 24. The stretcher 20 also includes handles 34 that one can grip with one's hand, or use to secure the stretcher 20 within an ambulance and/or helicopter while transporting the stretcher 20, and thus a person disposed on the stretcher 20. One may also use the handles 34 to secure a tether that can hoist the stretcher 20, and thus a person disposed on the stretcher 20, out of a dangerous and/or precarious situation.

The stretcher 20 addresses and overcomes the aforementioned limitations of conventional stretcher systems (known also as gurneys, patient recovery systems, portable patient transport devices, etc.) and may be used in lieu of a basket, rescue, scoop, or pole stretcher across the flat stretcher categories of medical transport, rescue transport, and evacuation. The stretcher 20 is also “jump-worthy”, meaning it meets the specifications desired in situations as previously mentioned.

FIG. 3 shows a view of a stretcher 40, according to another embodiment of the invention. In this and other embodiments, the rigid, inflatable stretcher system 20 includes three panels 42a, 42b and 42c. Each of the panels 42a, 42b and 42c is comprised of a durable, thermoplastic coated material in two layers, each layer joined together by drop-stitches, forming independent air-tight chambers (otherwise known as panels or bladders, or other name commonly known in the industry). Each chamber is isolated from the other by means of individual inflation valves 44 that do not allow air to travel from one chamber to another once the stretcher 40 is fully inflated. The rigid, inflatable drop-stitch design provides sufficient ruggedness, durability and shock mitigation (patient comfort and protection against potential transport injury) to overcome the limitations of current designs in use.

FIG. 4 shows a view of a stretcher 50, according to yet another embodiment of the invention. In this and other embodiments, the stretcher 50 includes a single panel 52 without a drop-stitch, and an I-beam 54 (here two) for rigidity. Although the stretcher 50 includes a single panel 52, the stretcher 50 may include more than one panel.

Referring back to FIG. 3, the stretcher 40 provides efficient transport and storage capability due to the nature of its construction, which is light and capable of being rolled up when deflated. In this and other embodiments, the rigid inflatable stretcher system 40 forms its shape from a series of three drop-stitch panels joined together by overlapping joints that are thermal welded together. The dimensions of this version are approximately 72″ long by 24″ wide by 2″ high, with each panel being approximately 24″ long by 24″ wide by 2″ high. (See FIG. 5). In other embodiments, the dimensions may be different.

The advantage of having multiple panels (three, less than three, or more than three) is performance related: if one individual panel or chamber is compromised, the inflatable stretcher system 40 may still be capable of performing its mission as the other panels are isolated from each other and will retain air pressure and therefore their shape and rigidity.

In yet another aspect of the present invention, another means by which to join the drop-stitch panels may be used including the use of glue or other suitable adhesives well-known to those in the art, as well as military-style buttons also well-known in the art.

Still referring to FIG. 3, in this and other embodiments, each drop-stitch panel 42a, 42b and 42c is inflated with compressed air or an inert gas, to achieve a pressure of at least 8 pounds per square inch (psi). In other embodiments, the panels are pressurized to a pressure of about 8 psi to about 12 psi. In still other embodiments, each panel 42a, 42b and 42c may be inflated to less than 8 psi or more than 12 psi, up to a pre-determined maximum safety limit. In this and other embodiments, each panel is constructed of two layers, joined together by nylon stitches, either laid out in a straight fashion or arranged in a cross-stitch (‘X’) manner, The cross-stitch may extend along the length of the stretcher 40, the width of the stretcher 40, both, or any other desired direction. In other embodiments, a single layer or more than two layers y be used to construct the panels 42a, 42b and 42c.

The number of drop-stitches included in a panel 42a, 42b and/or 42c may be any desired number capable of providing rigidity and a desired shape to the panel when the panel is inflated. Furthermore, the arrangement of the drop-stitches throughout the panel may also be as desired. For example in this and other embodiments, each panel 42a, 42b and 42c includes more than a hundred drop-stitches, evenly distributed throughout the panel.

In other embodiments, alternative materials for the stitches may be used, e.g., polyethylene terephthalate (PET) or other suitable natural or synthetic material well known in the art. In other embodiments, the drop-stitch panel layers may be comprised of polyurethane-coated woven nylon fabric, polyvinyl chloride (PVC), Kevlar, or graphene.

Referring to FIGS. 2a, 2b and 3, in these and other embodiments, each panel 24, 52a, 42b and 42c is about 2 inches thick when fully inflated. In other embodiments, other thicknesses may be used (for example, about 1 inch or greater than 2 inches). In this and other embodiments, the panel layers may be coated with certain coatings such as polyurethane coatings, techthane, or other specialized coatings well known in the art to enhance the durability, abrasion, and puncture resistance qualities of the chosen panel materials. Still other coatings may be applied to enhance the stretcher's ability to withstand high heat, as for example, in those situations in which the dangerous or precarious situation includes a fire.

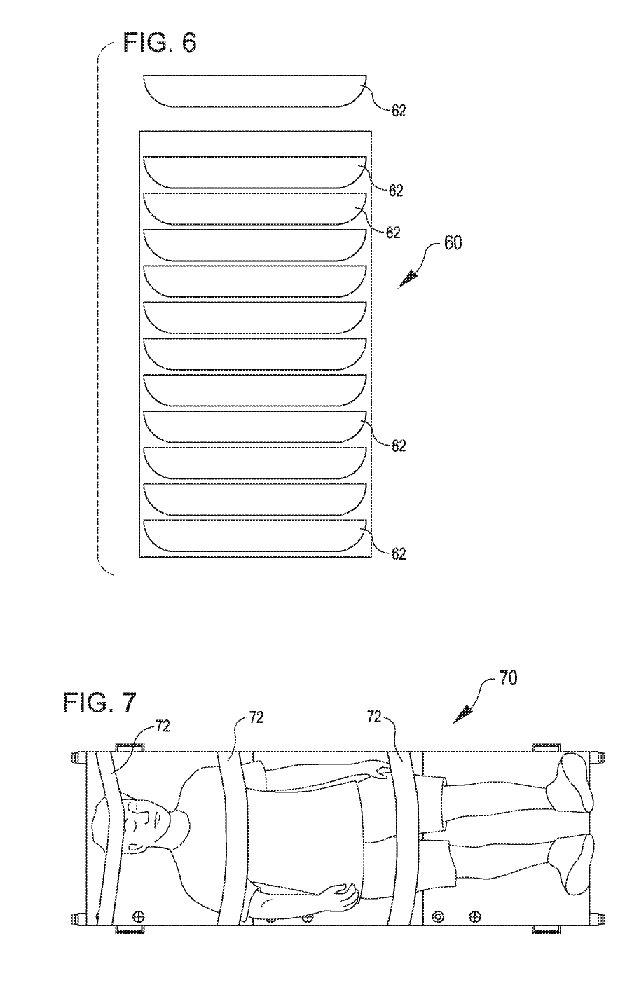

FIG. 6 shows a view of a panel 60 according to another embodiment of the invention. In this and other embodiments, Kevlar panels 62 are inserted in the underside of the panel 60 to provide protection against small arms fire or other hostile actions by enemy forces. These Kevlar panels 62 are inserted into specially designed pockets affixed by thermal welding or glue to a panel 60. The number of Kevlar (or other suitable bullet resistant material) panels 62 may be designed such that they will not interfere with the ability of the panel 60 to be rolled up, and thus allow a stretcher that includes the panel 60 to be stored in a backpack or other carrying bag suitable for the purpose of transporting the stretcher. The protective panels can be as few as three or as many as twelve, but may be more or less, depending on design.

Returning back to FIG. 3, in this and other embodiments, each panel 42a, 42b and 42c is inflated with compressed air. Compressed air may be obtained or produced from any readily available source, e.g., compressed air cylinders or air compressors, both of which are available from well-known commercial vendors or outlets. The compressed air is directed from the compression source to each panel through a network of inflation hoses and valves, forming the inflation manifold system. In other embodiments, an inert gas such as helium or another well-known inert gas such as another of the so-called noble gases and carbon dioxide (CO₂) may be used in lieu of or in addition to compressed air.

In this and other embodiments, each panel 42a, 42b and 42c may be inflated individually through the supplied inflation/deflation valve 44, which is attached to the panel. In other embodiments, each panel 42a, 42b and 42c may be inflated automatically through a valve system embedded in each baffle or bulkhead separating each panel for those versions of the stretcher 40 that include more than one panel. In this and other embodiments, inflation/deflation occurs at one point and each stretcher panel is inflated automatically. Inflation/deflation valves are commercially available from well-known sources in the art.

Still referring to FIG. 3, in this and other embodiments, each of the panels 42a, 42b and 42c includes a pressure relief valve (PRV) 46 to ensure that over-pressurization does not occur. These valves are commercially available from well-known sources in the art.

FIG. 7 shows a view of a stretcher 70, according to another embodiment of the invention. In this and other embodiments, the stretcher 70 includes a patient restraint system 72. The restraint system 72 are attached to the sides of the rigid inflatable stretcher system 70 at certain locations to secure the patient to the inflatable stretcher 70. In this and other embodiments, the restraint system 70 includes three straps. In other embodiments, more than three or less than three may be included.

In this and other embodiments, the straps may be made from commercially available webbing with buckles or other means of connecting and tightening the straps. These webbing devices may be attached to the rigid inflatable stretcher system 70 by glue or other adhesives; by stitching; or by use of a hook and pile system (commonly called Velcro).

In other embodiments, the straps may be made from polyurethane-coated nylon fabric, similar or identical to the same material from which the rigid inflatable stretcher system's panels are fabricated. In this embodiment, the straps can be attached to the sides of the stretcher 70 by adhesives or by thermal welding.

In other embodiments, the restraint system 72 may be located such that it secures the patient's shoulder area (upper torso) and lower leg area. In still other embodiments, the restraint system 70 may be located such that it secures the patient's upper torso, middle torso, and lower body area.

In this and other embodiments, the restraint system 70 includes a specially designed head strap. This strap may be used to stabilize patients with suspected spinal injuries. In this and other embodiments, the head strap is designed to conform to the top of the patient's head, holding it securely in place.

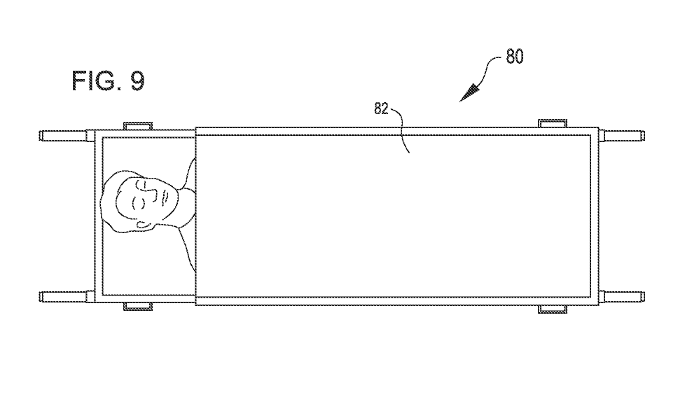

FIG. 9 shows a view of the stretcher 80, according to yet another embodiment of the invention. The stretcher 80 includes a stability pocket 82 to provide maximum stability for severely injured patients. In this and other embodiments, this pocket 82 is also is designed to secure the patient to the rigid inflatable stretcher system 80 to allow for safe extraction by helicopter. The pocket 82 is a layer of thermoplastic coated nylon fabric (or other suitable material well-known in the art) that wraps around the patient's body from the top of the shoulder area to the bottom of the feet. The pocket 82 may be affixed after the patient is placed on the stretcher 80, and secured by hook and pile (or other suitable means), or the pocket 82 may be permanently affixed by being attached to the bottom (or underside) of the stretcher 80 by thermal welding or gluing.

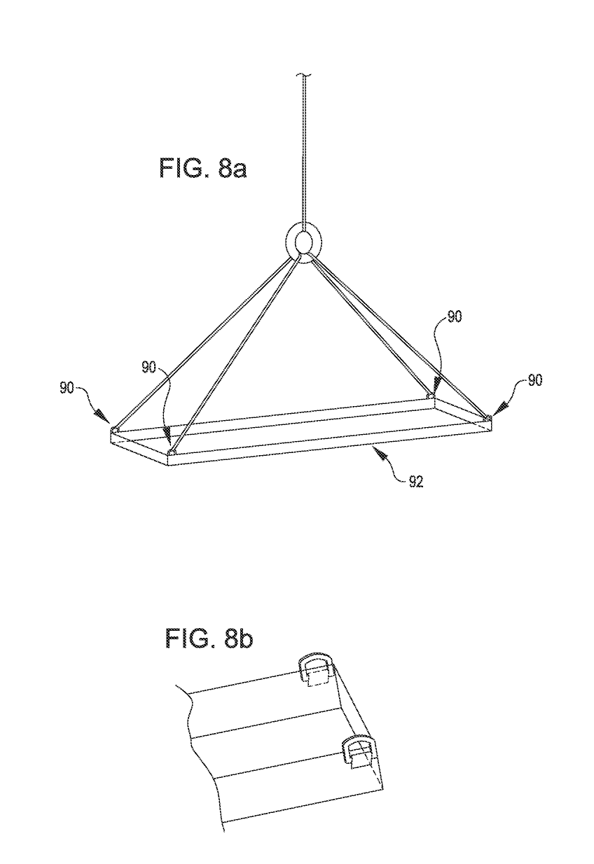

FIG. 8a shows a view of a hoisting system 90 included in a stretcher 92, according to an embodiment the invention. FIG. 8b shows a partial view of the hoisting system 90 shown in FIG. 8a, according to an embodiment of the invention. The hoisting system 90 allows for safe hoisting and extraction by helicopter, and allows the inflatable stretcher 92 to be hoisted into the air, whether to allow the patient to be moved by helicopter or to be lifted and placed onto another vehicle for rapid transport.

In this and other embodiments, the hoisting system 90 includes commercially supplied and properly rated D-rings attached to the rigid inflatable stretcher system 92 through means commonly known in the art. The D-rings are placed in four places, two each at the top (or front) and two at the back (or bottom), to allow for a 4-point lift. (See FIG. 8a). Other numbers of 0-rings may be used (e.g., three D-rings, allowing for a 3-point lift). The hoisting system 90 may be custom-built, and may be made from nylon webbing, thermoplastic coated synthetic fabric (e.g., polyurethane-coated nylon or PET fabric), injection or extrusion molded high density polyethylene, etc., processes well-known in the art.

Referring back to FIGS. 1-3, the stretchers 20 and 40 include handles 34 to carry the stretcher 20 or 40 with a patient securely attached. In this and other embodiments, four lifting handles 34 are provided, two each at the front (or head end) of the stretcher 20 or 40, and two each at the back (or foot end) of the stretcher 20 or 40. In other embodiments, other amounts of lifting handles 34 may be included. The lifting handles 34 may be sourced from commercially available sources and may be made from various materials (plastic, rubber, synthetic rubber, aluminum, etc.). The lifting handles 34 may also be made from thermoplastic coated synthetic fabric (e.g., polyurethane-coated nylon fabric) and affixed to the rigid inflatable stretcher by means of adhesives or thermal welding commonly known in the art.

In this and other embodiments, the lifting handles 34 are attached to the sides of the rigid inflatable stretcher 20 or 40 by being inserted into specially designed pockets that are glued or thermal welded to the stretcher. In other embodiments, the lifting handles 34 may be made from the same or similar materials as the rigid inflatable stretcher 20 or 40, and can be glued or thermal welded to the side using a specially designed fabric patch commonly known in the art.

Referring to FIG. 3, four lifting poles 48 are provided, two each at the front end of the rigid inflatable stretcher 40 and two each at the back end, In other embodiments, three lifting poles 48 may be provided. In still other embodiments, other amounts may be used. The lifting poles 48 may be permanently attached by being glued into specially designed holding pockets. Or, the lifting poles 48 may not be permanently affixed, and may be inserted into the rigid inflatable stretcher 40 after the stretcher 40 is inflated and secured by appropriate means.

In this and other embodiments, the lifting poles 48 are telescopic, meaning they can be pushed in to shorten the length of the pole (e.g., to facilitate rolling up the inflatable stretcher), or pulled out to increase the length (e.g., to improve the carrying leverage). These lifting poles 48 may be made from various lightweight and durable materials (e.g., aluminum, rigid plastics such as HDPE, Kevlar, graphene, etc.). These lifting poles 48 may also be procured from commercially available sources or designed specifically for the stretcher 40.

In other embodiments, the stretcher 40 may include a wheel to allow one to transport a patient over land. The wheel may be affixed to the back end of the rigid inflatable stretcher 40 through various means well known in the art. The wheel may be made from a variety of materials, including rigid plastic, rubber, synthetic rubber, aluminum, etc. In some embodiments, the wheel is four inches in diameter with a one-inch surface width. In other embodiments, different wheel sizes may be used. In still other embodiments the stretcher 40 may include more than one wheel.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A rigid, inflatable stretcher comprising:
a main section;
a restraint system;
a hoisting system; and
a system for land transport.

2. The stretcher of claim 1 wherein the main section includes at east one inflatable panel.

3. The stretcher of claim 2 wherein the at least one inflatable panel includes a drop-stitched material.

4. The stretcher of claim 2 wherein the at least one inflatable panel includes a specially coated thermoplastic-coated natural or synthetic fiber material.

5. The stretcher of claim 2 wherein the main section includes two inflatable panels and each of the panels can be inflated independently of the other.

6. The stretcher of claim 5 wherein each panel can be inflated to a designated pressure to provide rigidity and shock mitigation.

7. The stretcher of claim 1 wherein the main section includes an inflatable I-beam to provide rigidity.

8. The stretcher of claim 1 wherein the stretcher can be inflated to a very high pressure when constructed from drop-stitch material, providing superior rigidity.

9. The stretcher of claim 1 wherein the stretcher can be deflated and rolled up for efficient storage and transport.

10. The stretcher of claim 1 wherein the restraint system is configured to secure a person to the main section.

11. The stretcher of claim 1 wherein the hoisting system includes four D-rings to allow the stretcher to be hoisted.

12. The stretcher of claim 1 wherein the transport system includes two wheels affixed to an underside of a rear end of the stretcher, allowing for land transport.
